(19) United States
(12) Patent Application Publication
(10) Pub. No.: US 2026/0327053 A1
(43) Pub. Date: Oct. 22, 2026

(54) RADIO-CONTROLLED VEHICLE

(71) Applicant: MDB SRL, LANCIANO (CH) (IT)

(72) Inventor: Mario Di Biase, LANCIANO (CH) (IT)

(73) Assignee: MDB SRL, LANCIANO (CH) (IT)

(21) Appl. No.: 19/115,077

(22) PCT Filed: Sep. 26, 2023
(86) PCT No.: PCT/IB2023/059497

§ 371 Date: Mar. 25, 2025

(30) Foreign Application Priority Data
Sep. 27, 2022 (IT) 102022000019851

(51) Int. Cl. B66F 9/075; B66F 9/22

(52) U.S. Cl. CPC B66F 9/07581; B66F 9/22

(57) ABSTRACT

A vehicle comprising a frame having a longitudinal axis a transversal axis, and a vertical axis; the vehicle having a drive unit, a control unit, a kinetic unit, a remote control; wherein said control unit is configured to exchange information and data with said remote control to regulate said drive unit; wherein said frame has a fixed portion and a movable portion; wherein at least a portion of said drive unit is fixed to said movable portion; said vehicle having a lifting system which is interposed between the fixed portion and the movable portion and is configured to mutually move said movable portion relative to said fixed portion along said vertical axis; wherein said lifting system has a plurality of actuators.

### CROSS-REFERENCE TO RELATED APPLICATIONS

This Patent Application claims priority from Italian Patent Application No. 102022000019851 filed on Sep. 27, 2022, the entire disclosure of which is incorporated herein by reference.

### TECHNICAL FIELD

This invention patent application relates to an improved radio-controlled vehicle.

In particular, this invention relates to a radio-controlled vehicle configured to operate equipment subject, during use, to high stress.

Advantageously, the radio-controlled vehicle according to the present invention comprises a compact kinetic unit supporting its own frame, i.e., it keeps it suspended, a few centimetres from the ground; in this way, the radio-controlled vehicle according to the present invention is particularly compact, and therefore, is easily transportable and can be used in confined spaces.

The type of final application of a radio-controlled vehicle according to the present invention mainly depends on the type of installed equipment.

For example, the present invention relates to a radio-controlled vehicle that can be used as a folding forklift. In this case, the radio-controlled vehicle according to the present invention is equipped with a tip-up lifting unit. Folding forklifts are used in the road haulage sector. Folding forklifts are usually housed inside special seats in the lower part of vehicle trailers. It is therefore important to be able to reduce the dimensions of the folding forklifts as much as possible, while keeping the same load-handling capacity.

According to a further example, the present invention relates to a radio-controlled vehicle which can be used in mines, or in narrow underground passages and on uneven ground, for tunnelling and/or for transport. In this case, the radio-controlled vehicle according to the present invention is equipped with a bucket or equivalent equipment.

Advantageously, the radio-controlled vehicle according to the present invention is configured to be able to move safely on ramps, slopes, rough terrain, and the like.

### PRIOR ART

Forklifts for lifting and transporting goods are well known, e.g., EP 2377806 B1 describes a forklift in which the lifting unit is foldable and can be arranged, selectively, in a position selected from a group of different positions. The possible positions of the lifting unit include a fully open position and a fully closed position.

According to the solution described in EP 2377806 B1, the engine and other components (such as the hydraulic actuators, radiator, and tank) are housed in an engine compartment which is located in the rear portion of the truck and is vertically movable. This provides free space within the forklift base into which the lifting unit can be completely folded when it is in the closed position.

The engine compartment with its load is configured to counterbalance the lifting unit during use.

Well-known forklifts have the disadvantage that, in use, the engine compartment must run along a vertical slide to counterbalance the lifting unit and/or to raise the engine compartment above the supporting surface and allow the forklift to move on steep ground without hitting the engine compartment against the ground. In particular, the engine compartment is raised, in use, to prevent it from colliding with the ground or obstacles on the ground, also taking into account the compactness of the radio-controlled vehicle itself and the short distance between the frame and the ground.

Disadvantageously, the capacity of a well-known forklift to lift the engine compartment is limited. Therefore, this limits the capacity of counterbalancing the lifting unit and, accordingly, the overall lifting capacity of the forklift.

### DESCRIPTION OF THE INVENTION

The object of the present invention is to provide an improved radio-controlled vehicle, which, in particular, can lift heavier loads than the well-known solutions.

According to the present invention, a radio-controlled vehicle is provided as recited in the appended claims.

### BRIEF DESCRIPTION OF THE DRAWINGS

The invention will now be described with reference to the accompanying drawings, which illustrate a non-limiting embodiment thereof, in which:

FIG. 1 is a view of a radio-controlled vehicle according to the present invention in an operating configuration.

FIG. 2 is a side view of the radio-controlled vehicle in FIG. 1 in a first operating configuration;

FIG. 3 is similar to FIG. 2 and shows the radio-controlled vehicle in a further operating configuration;

FIG. 4A is a perspective view of a detail of the radio-controlled vehicle according to the present invention;

FIG. 4B is an exploded view of the detail in FIG. 4A;

FIG. 5 is a plan view of the detail in FIG. 4A;

FIG. 6 is a section along the line VI-VI in FIG. 5; and

FIGS. 7A, 7B, 7C, and 7D show a further detail of the radio-controlled vehicle according to the present invention in different respective operating configurations.

### PREFERRED EMBODIMENT OF THE INVENTION

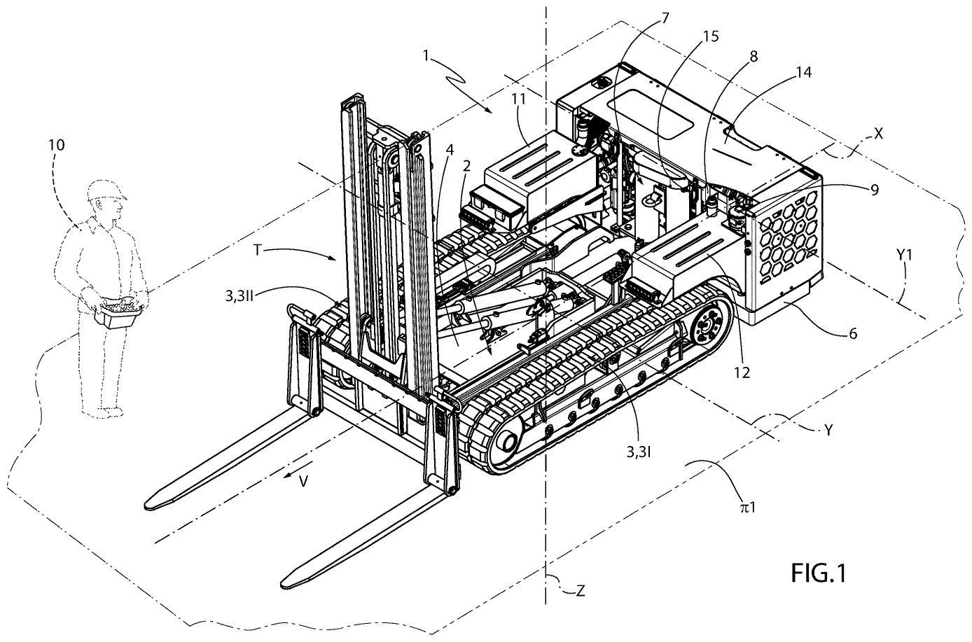

Reference number 1 in FIG. 1 indicates, as a whole, a radio-controlled vehicle according to the present invention. The radio-controlled vehicle 1 is configured to operate a tool T. According to the example shown, the tool T is a lifting unit and the radio-controlled vehicle 1 is a radio-controlled forklift. According to a variant, not shown, and without losing generality, the tool T can be selected from a group of different tools; for example, the tool T can comprise an articulated arm which, in turn, operates a bucket (for digging and/or transporting material), an air hammer, a chopper, or the like. Advantageously, the radio-controlled vehicle 1 is an excavator for tunnelling and/or transporting soil; in this case, the tool T is an articulated arm manipulating a bucket. Reference will be made hereinafter to the application of the radio-controlled vehicle 1 as a forklift (FIG. 1), however the features described and illustrated herein also apply to any other type of use of the radio-controlled vehicle 1 (e.g., an excavator as mentioned above) as the final application substantially depends on the type of tool T installed.

The radio-controlled vehicle 1 has:
a longitudinal axis X, also known as the roll axis, substantially parallel to the supporting plane π1 of the radio-controlled forklift 1;
a vertical axis Z, also known as the yaw axis, substantially perpendicular to the supporting plane π1; and
a transversal axis Y, also known as the pitch axis, substantially perpendicular to both the longitudinal axis X and the vertical axis Z.

Hereinafter and in the figures, this reference system is used for all the components of the radio-controlled vehicle 1.

Terms such as front, back/rear, top/upper, bottom/lower, right, left (or the like) are used with reference to the normal operation of the radio-controlled vehicle 1 when it moves in the forward direction v on the supporting plane π1 (a plane parallel to plane XY).

The suffixes I and II are used to indicate the components on the left-hand side and the right-hand side, respectively, of the radio-controlled forklift 1 according to the forward direction v.

The superscripts ′ and ″ are used to indicate the components on the front side and the rear side, respectively, of the radio-controlled forklift 1.

The radio-controlled vehicle 1 comprises: a frame 2 and a kinetic unit 3. According to the example shown, the kinetic unit 3 comprises two tracks 3I, 3II (shown schematically). According to a variant, not shown, instead of the tracks 3I, 3II, the kinetic unit 3 can comprise wheels or other equivalent rolling elements.

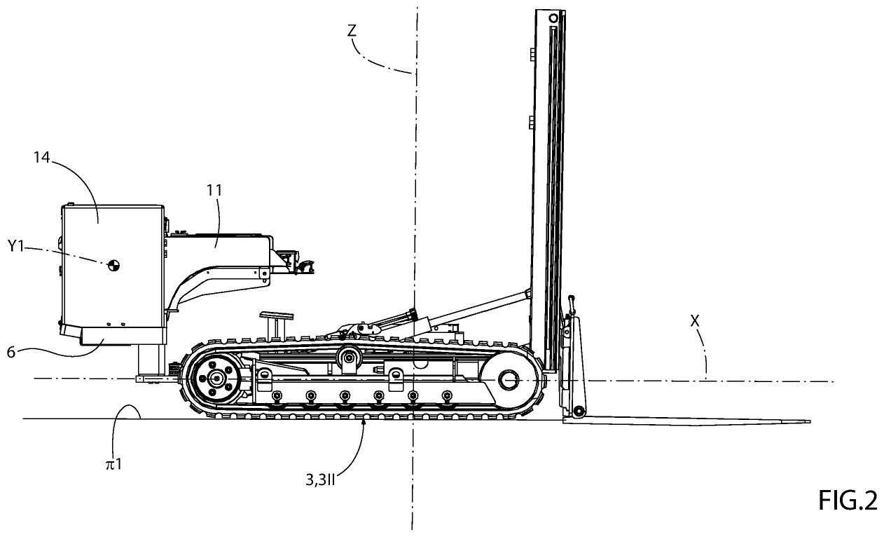

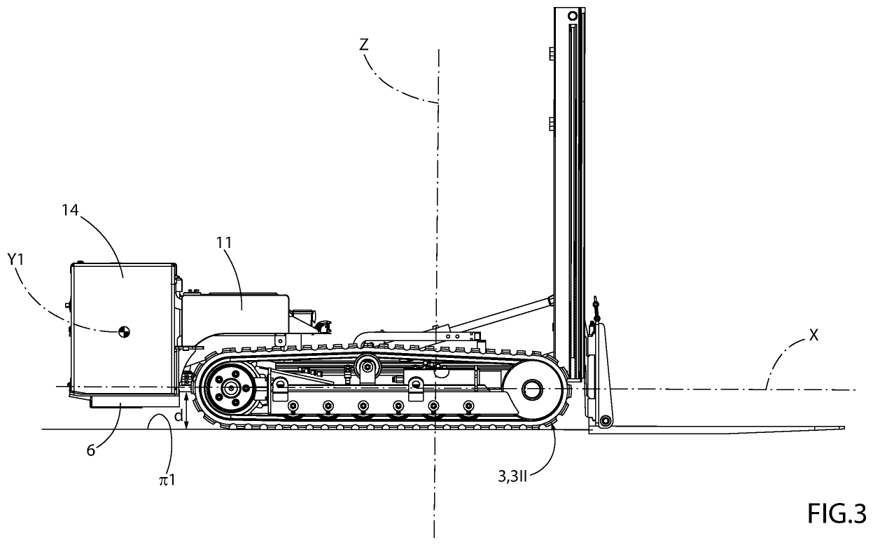

FIGS. 2 and 3 show the radio-controlled vehicle 1 in two different respective operating configurations. In particular, FIG. 2 shows the radio-controlled vehicle 1 fully open, as will be better illustrated below, and FIG. 3 shows the radio-controlled vehicle 1 fully closed.

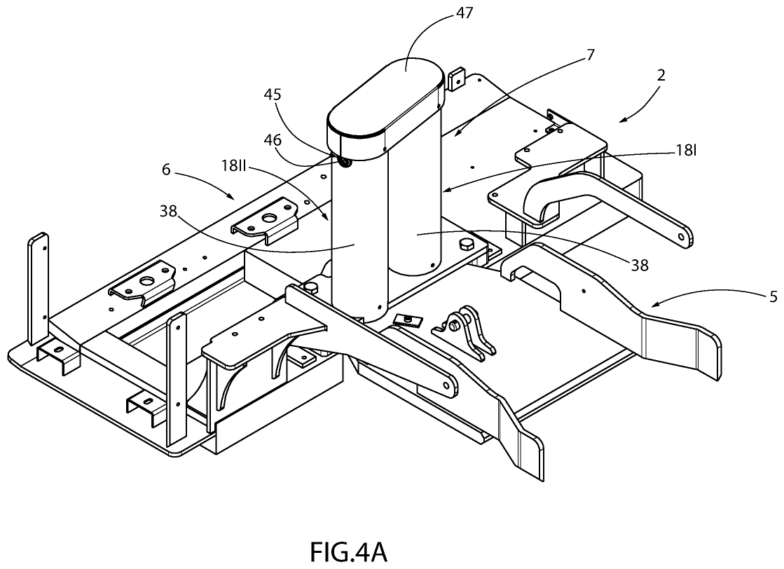

FIG. 4 shows a detail of the frame 2 of the radio-controlled vehicle 1. In fact, in order to modify the configuration of the radio-controlled vehicle 1 as shown by way of example (but not in a limiting way) in FIGS. 2 and 3, the frame 2 comprises a fixed portion 5 and a movable portion 6.

Both the fixed portion 5 and the movable portion 6 are substantially parallel, in use, to the supporting plane π1. According to the example shown, the movable portion 6 can be posterior to the fixed portion 5 and protrudes cantilevered posteriorly from the kinetic unit 3. According to a variant, not shown, the movable portion 6 is in front of the fixed portion 5 and is arranged in a frontal position of the radio-controlled vehicle 1.

According to the example shown, the frame 2 comprises a central portion 4 which is configured to house at least part of the tool T (FIG. 3) and/or attachments for the tool T. The central portion 4 is interposed between the tracks 3I, 3II. By way of non-limiting example, the central portion 4 is a floor.

The frame 2 is substantially parallel, in use, to the supporting plane π1.

Advantageously, the radio-controlled vehicle 1 is compact.

Advantageously, the radio-controlled vehicle 1 comprises a lifting system 7 connecting the movable portion 6 to the fixed portion 5 of the frame 2 and is configured to selectively vary the mutual positions of the movable portion 6 and the fixed portion 5. In particular, the lifting system 7 is configured to translate the movable portion 6 relative to the fixed portion 5 along the vertical axis Z, as will be better illustrated below.

The radio-controlled vehicle 1 also comprises a drive unit 8, a control unit 9, and a remote control 10.

The drive unit 8 comprises a set of machines and/or systems configured to activate the radio-controlled vehicle 1 and any tool T. For example, the drive unit 8 may comprise one or more of the following components (the following is an exemplary, non-exhaustive list):
an engine (for example, an internal combustion engine, an electric motor, a hybrid engine, or an equivalent engine);
a hydraulic system for circulating pressurized oil F (e.g., the hydraulic system comprises a pump unit and conduits for selectively feeding hydraulic oil to hydraulic actuators); and
a radiator (e.g., a water-oil cooler).

The control unit 9 is configured to remotely exchange information and/or data with a remote control 10. The control unit 9 regulates each component of the drive unit 8, in particular according to working parameters set by the operator by means of the remote control 10.

Advantageously, the radio-controlled vehicle 1 also comprises a bonnet 14, which is fixed to the movable portion 6 and configured to delimit, together with the movable portion 6 itself, an engine compartment 15. Advantageously, the drive unit 8 is installed on the movable portion 6 of the frame 2 and housed, at least partially, inside the engine compartment 15.

According to the example shown, the bonnet 14 is a box-like body, substantially parallelepiped in shape, with the major longitudinal axis Y1 parallel to the transversal axis Y.

According to the example shown, the radio-controlled vehicle 1 comprises a fuel tank 11 and a hydraulic oil tank 12. Preferably, the fuel tank 11 and the hydraulic oil tank 12 are fixed to the movable portion 6 of the frame 2. In this way, the positions of the fuel tank 11 and the hydraulic oil tank 12 along the axis Z can be varied according to the position of the movable portion 6 relative to the fixed portion 5.

According to the example shown, the fuel tank 11 and the hydraulic oil tank 12 protrude cantilevered from the bonnet 14 and above the central portion 4 of the frame 2. The fuel tank 11 and the hydraulic oil tank 12 are configured to counterbalance each other.

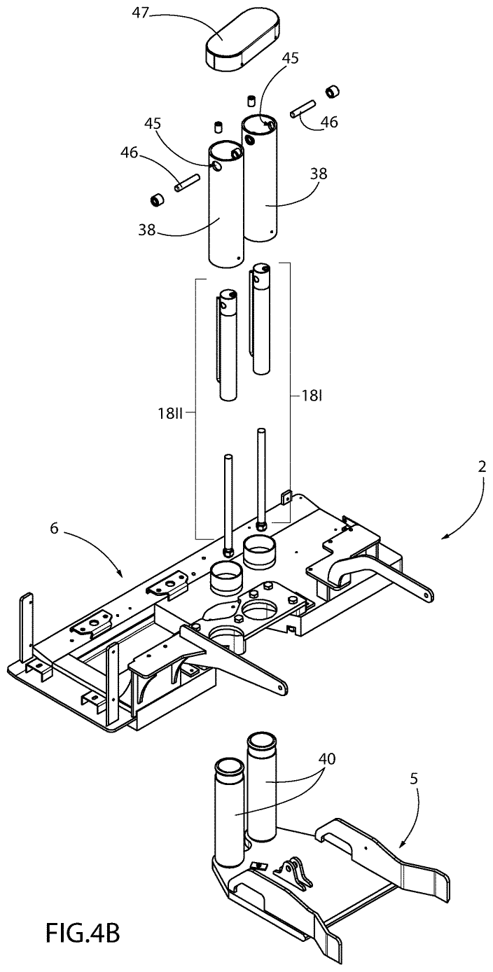

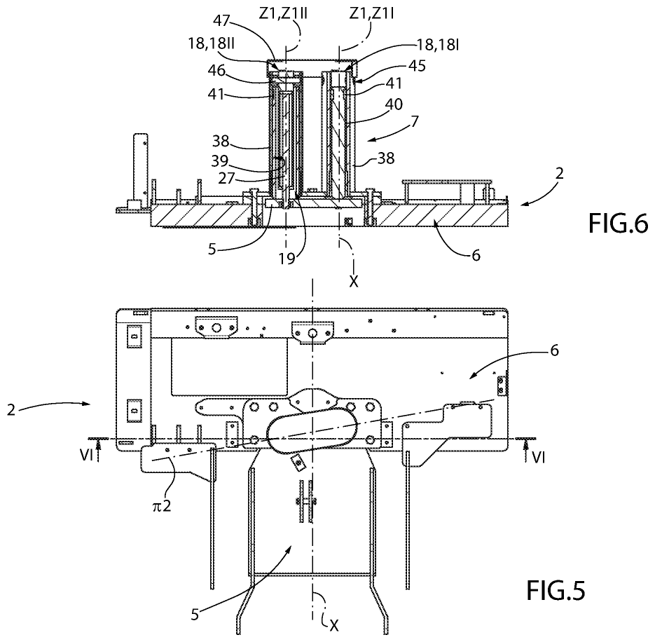

FIG. 6 shows the section VI-VI of FIG. 5 and shows, in section: the fixed portion 5, the movable portion 6, and the lifting system 7. The lifting system 7 advantageously comprises a plurality of parallel, linear actuators 18. Without losing generality, according to the example shown, the lifting system 7 comprises two actuators 18, hereinafter referred to as the left actuator 181 and the right actuator 18II.

Preferably, each actuator 18 is a linear actuator. The number and arrangement of the actuators 18 may differ from what is shown. It is noted that the longitudinal axes of the actuators 18 according to the example shown lie in a plane 12, which is perpendicular to the supporting plane π1 and is inclined at an angle a to the longitudinal axis X (FIG. 5).

According to the example shown, both actuators 18 are of the hydraulic type. Without losing generality, each actuator 18 can be selected from a group of actuators which differ from one another by type. For example, alternatively, an actuator can be a linear guide and/or a rack-and-wheel, nut-screw, or equivalent system.

According to the example shown, the actuators 18I and 18II are identical to each other, therefore a single actuator 18 is described below, the features of which are to be considered valid mutatis mutandis for the other one, without the need to repeat them for the sake of brevity.

According to the example shown, each actuator 18 has a longitudinal axis Z1 substantially parallel to the vertical axis Z. Therefore, hereinafter the terms upper and lower are used with reference to this positioning.

Each actuator 18 comprises a double-acting hydraulic cylinder 19.

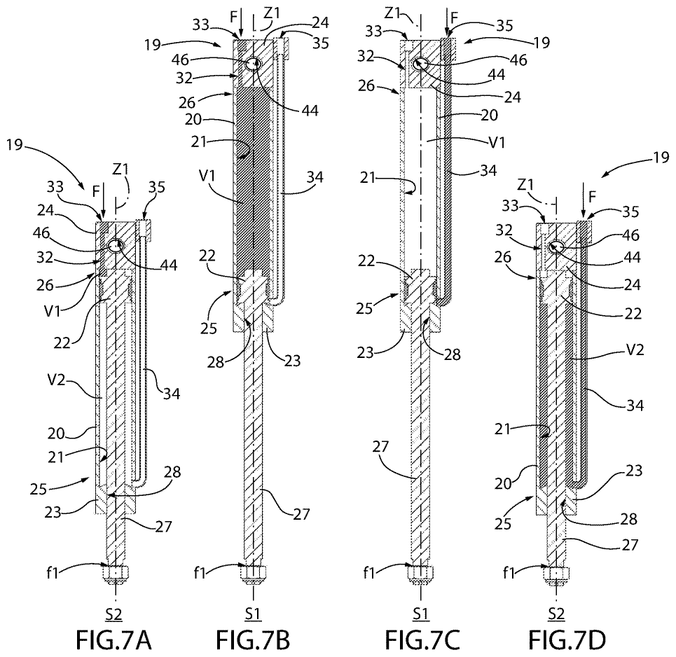

FIGS. 7A to 7D detail a hydraulic cylinder 19 in different respective operating configurations, as will be better illustrated below.

Each hydraulic cylinder 19 comprises:
a tubular body 20 substantially coaxial with the longitudinal axis Z1 and delimiting an inner cavity 21;
a piston 22 which is inserted inside the inner cavity 21 and is movable along the longitudinal axis Z1. The piston 22 divides the cavity 21 into two variable-volume chambers V1 and V2 which are fluidically isolated from each other (in a known way and schematically illustrated, for example, by seals fitted on the piston 22 which slide on the tubular body 20). Hereinafter, the chambers are referred to as the lifting chamber V1 and the closing chamber V2;
two cylinder heads, hereinafter referred to as the lower cylinder head 23 and the upper cylinder head 24, which are fixed to a lower end 25 and an upper end 26, respectively, of the tubular body 20, so as to seal the inner cavity 21;
a rod 27 which is fixed to the piston 22 and can slide through a through-hole 28 of the lower cylinder head 23. The rod 27 of the hydraulic cylinder 19 is fixed to the fixed portion 5 of the frame 2. According to the example shown in FIG. 6, the rod 27 of the hydraulic cylinder 19 protrudes, in use, from the bottom of the tubular body 20. The rod 27 has a threaded end f1 which is bolted into a respective hole 50 of the fixed portion 5 of the frame 2.

Each hydraulic cylinder 19 further comprises:
a conduit 32, which fluidically connects the lifting chamber V1 to a junction mouth 33;
a conduit 34, which fluidically connects the closing chamber V2 31 to a junction mouth 35.

According to the example shown, the conduit 32 is made within the upper cylinder head 24, whereas the conduit 34 is external to the tubular body 20.

Advantageously, each actuator 18 is telescopic. According to the example shown in FIGS. 4A, 4B, 5 and 6, each actuator 18 comprises an outer liner 38 and an inner liner 40, which are tubular bodies inserted into each other that can slide relative to each other along their own longitudinal axis Z1.

In particular, the hydraulic cylinder 19 is inserted inside the inner liner 40, which, in turn, is inserted inside the outer liner 38. The inner liner 40 and the outer liner 38 are mutually movable along the longitudinal axis Z1.

The hydraulic cylinder 19 is fixed to the inner liner 40. The outer liner 38 is fixed to the movable portion 6 of the frame 2, whereas the hydraulic cylinder 19 is fixed to the fixed portion 5; in this way, the actuator 18 is telescopic and the hydraulic cylinder 19 is contained within the outer liner 38 and the inner liner 40 in any operating configuration.

According to the example shown in FIGS. 4A, 4B, 5 and 6, the outer liner 38 has an inner cavity 39, and the inner liner 40 has an inner cavity 42 (FIG. 6).

Advantageously, each actuator 18 further comprises an inner liner 40 within which the hydraulic cylinder 19 is, at least partly, inserted. The inner liner 40 is interposed between the hydraulic cylinder 19 and the outer liner 38.

The outer liner 38 and the inner liner 40 can mutually slide along the longitudinal axis Z1. Preferably, the actuator 18 comprises a sealing system 41, which is interposed between the inner liner 40 and the outer liner 38. Preferably, the sealing system 41 comprises seals preferably made of elastic material and configured to prevent material (solid or liquid) from passing between the inner liner 40 and the outer liner 38. Advantageously, the sealing system 41 is configured to elastically compensate for any misalignments or inclinations between the inner liner 40 and the outer liner 38.

The outer liner 38 is fixed, directly or indirectly, to the hydraulic cylinder 19.

According to the example shown, the upper cylinder head 24 of the hydraulic cylinder 18 has a through-hole 44 substantially transversal to the longitudinal axis Z1. The outer liner 38 has corresponding radial holes 45 configured to be aligned, in use, with the through-hole 44.

The actuator 18 further comprises a pin 46 which is inserted through the holes 45 of the outer liner 38 and the hole 44 of the upper cylinder head 23 of the hydraulic cylinder 19.

The pin 46 constrains the outer liner 38 to the upper cylinder head 23 of the hydraulic cylinder 19.

The outer liner 38 is fixed to (or made in one piece with) the movable portion 6 of the frame 2.

The inner liner 40 is fixed to the fixed portion 5 of the frame 2.

Advantageously, the lifting system 7 comprises a cover 47 which covers the top of both the actuators 18I and 18II to protect them from external agents.

In addition, the cover 47 is configured so as to allow the passage of pipes or equivalent elements for connecting the junction mouths 33 and 35 to the hydraulic system of the radio-controlled vehicle 1.

According to the example shown, the lifting chamber V1 is arranged above the closing chamber V2 relative to the piston 22. In this way, during use, the piston 22 is moved from the raised position S1 (FIGS. 7B and 7C) to the closed position S2 under the thrust of the force of gravity, this descent being counteracted by the oil sent under pressure into the closing chamber V2. In this way, advantageously, the supply of pressurized oil F counteracts the descent of the movable portion 6, thereby preventing the engine compartment 15 from substantially falling during the lowering.

Advantageously, the movable portion 6 of the frame 2 is fixed to the lower end of the outer liner 38, thus obtaining the maximum possible translation of the movable portion.

Advantageously, the provision of two actuators 18 side by side to form the lifting system 7 allows the load of the engine compartment 15 to be distributed on parallel actuators 18. This reduces the risk of breakage and/or bending of the rods 27 at buckling load.

Advantageously, the actuators 18I and 18II are side by side in a plane 12 perpendicular to the supporting plane π1 and inclined at an angle a less than 90° to the longitudinal axis X. This gives the lifting system greater rigidity, thereby reducing the risk of any bending of the actuators 18.

The operation of the lifting system 7 for translating the engine compartment 15 of the radio-controlled vehicle 1 relative to the supporting plane π1 is described below.

An operator via the remote control 10 exchanges information and data with the control unit 9. The control unit 9, in turn, regulates the hydraulic system 12. Therefore, the operator is able to control the lifting and lowering of the engine compartment 15 via the remote control 10.

In order to control the lifting of the engine compartment 15, the control unit 9 regulates the hydraulic system 12 so that the pressurized oil F is sent to the junction mouth 33 of each hydraulic cylinder 19.

Preferably, the pressurized oil F is sent simultaneously to all the actuators 18 (in the example shown, 18I and 18II). In this way, all the actuators 18 are simultaneously translated, so that the engine compartment 15 is kept substantially parallel to the supporting plane π1.

FIGS. 7A and 7B show the final moments of the transition of a hydraulic cylinder 19 from the closed position S2 to the raised position S1.

During the lifting phase, the pressurized oil F is fed into the lifting chamber V1 in order to push the piston 22 towards the lower cylinder head 23 of the tubular body 20. During the lifting phase, the rod 27 is pushed out of the tubular body 20. FIG. 7B shows the moment when the piston 22 is in the fully raised position S1.

FIGS. 7C and 7D show the transition of a hydraulic cylinder 19 from a raised position S1 to a closed position S2.

FIG. 7C shows the conversion moment at which the lifting chamber V1 is placed in communication with the discharge (i.e., the pressure inside the lifting chamber V1 drops) and the closing chamber V2 is supplied with the pressurized oil F.

Advantageously, the lifting system 7 of the type described above allows the position of the engine compartment 15 to be varied depending on the specific conditions of use of the radio-controlled vehicle 1. For example, it allows the engine compartment 15 to be lifted from a lowered position very close to the supporting plane π1, so that the radio-controlled vehicle 1 can be moved forward even on an incline and/or on rough terrain.

Otherwise, the lifting system 7 can be useful for counterbalancing a load applied to the tool T by moving the engine compartment 15 in order to change the position of the centre of gravity of the radio-controlled vehicle 1.

Advantageously, the lifting system 7 of the type described above is more robust than a lifting system 7 of the conventional type and therefore allows higher loads to be lifted, thus ensuring greater safety.

Furthermore, advantageously, the fact that the lifting system 7 comprises two actuators 18 aligned on a plane π2 inclined relative to the longitudinal axis X of the radio-controlled vehicle 1 reduces the risks of any bending of the actuators 18 (in particular, it reduces the risks of bending under buckling load).

Advantageously, the fact that an actuator 18 has an outer liner 38 fitted onto an inner liner 40 allows the engine compartment 15 to be precisely centred on the fixed portion 5 of the frame 2. In addition, the presence of a sealing system 41 between the outer liner 38 and the inner liner 40 makes it possible to elastically compensate for any misalignments and inclinations.

Advantageously, the fact that each hydraulic cylinder 19 is a double-acting cylinder with the closing chamber V2 located below the opening chamber V1 relative to the piston 22 allows the descent of the engine compartment 15 to be cushioned during the closing operation and reduces the risk of the engine compartment 15 falling precipitously downwards under the action of its own weight.

1. A radio-controlled vehicle comprising a frame having a longitudinal axis, a transversal axis and a vertical axis; the vertical axis being perpendicular to a supporting plane; the vehicle comprising a drive unit, a control unit a kinetic unit a remote control; wherein said control unit is configured to exchange information and/or data with said remote control to regulate said drive unit wherein said frame comprises, in turn, a fixed portion and a movable portion; wherein at least a portion of said drive unit is fixed to said movable portion; said vehicle comprising a lifting system, which is interposed between the fixed portion and the movable portion and is configured to move along said vertical axis said movable portion relative to said fixed portion; wherein said lifting system comprises a plurality of actuators.

2. The vehicle according to claim 1, wherein the lifting system comprises two actuators; wherein said actuators; are linear actuators; each actuator having a respective longitudinal axis; wherein the longitudinal axes of said actuators are parallel to said vertical axis and lie in a second plane which is perpendicular to the supporting plane and is inclined at an angle to said longitudinal axis.

3. The vehicle according to claim 1, wherein each actuator comprises a double-acting hydraulic cylinder comprising, in turn:
a tubular body delimiting an inner cavity;
a piston, which is inserted in the inner cavity and subdivides the inner cavity into a first chamber and a second chamber; wherein each chamber has a variable volume; wherein said first chamber and said second chamber are fluidically isolated from each other;
a first cylinder head and a second cylinder head, which are fixed to a first end and a second end respectively, of the tubular body, to seal the inner cavity;
a rod which is fixed to the piston and can slide through a through-hole of the second cylinder head.

4. The vehicle according to claim 3, wherein said first chamber is defined by the portion of said inner cavity interposed between the piston and the first cylinder head wherein said second chamber is defined by the portion of said inner cavity between the piston and the second cylinder head; wherein said first cylinder head is arranged superiorly to said second cylinder head relative to said second longitudinal axis.

5. The vehicle according to claim 3, wherein said rod of the hydraulic cylinder is fixed to the fixed portion of the frame wherein said second cylinder head is fixed to the movable portion of the frame.

6. The vehicle according to claim 3, wherein each hydraulic cylinder comprises: a first conduit, which fluidically connects the first chamber with a first mouth a second conduit which fluidically connects the second chamber with a second mouth wherein, the first conduit is realized within the first cylinder head and the second conduit is external to the tubular body; said first mouth receives, in use, pressurized oil to raise the movable portion and said second mouth receives, in use, pressurized oil to lower the movable portion.

7. The vehicle according to claim 3, wherein each actuator is telescopic.

8. The vehicle according to claim 7, wherein each actuator comprises an outer liner and an inner liner; the outer liner and the inner liner are tubular; the hydraulic cylinder is housed, at least in part, inside the inner liner; the inner liner is housed, in turn, inside the outer liner; the outer liner and the inner liner are mutually slidable along the longitudinal axis of the hydraulic cylinder; each actuator; comprising a sealing system, which is interposed between the inner liner and the outer liner and is made of elastic material; the inner liner is fixed to the hydraulic cylinder; the outer liner is fixed to the movable portion of the frame; the rod of the hydraulic cylinder is fixed to the fixed portion of the frame.

9. The vehicle according to claim 1, wherein said drive unit comprises a set of machines and/or systems configured to activate the vehicle and any tool; said drive unit comprises one or more of the following components: an engine, a hydraulic system, and a radiator.

10. The vehicle according to claim 1, wherein the control unit regulates each element of the drive unit in function of working parameters set by the operator by means of the remote control.
